(19) United States
(12) Patent Application Publication
(10) Pub. No.: US 2006/0033905 A1
(43) Pub. Date: Feb. 16, 2006

(54) Pellicle-reticle methods with reduced haze or wrinkle formation

(76) Inventors: Mahmood Toofan, Gilory, CA (US); Florence O. Eschbach, Portola Valley, CA (US)

Correspondence Address: SCHWABE, WILLIAMSON & WYATT, PACWEST CENTER, SUITE 1900, 1211 S.W. FIFTH AVE., PORTLAND, OR, 97204, US

(21) Appl. No.: 10/919,548

(22) Filed: Aug. 16, 2004

(51) Int. Cl. G03B 27/62

(52) U.S. Cl. 355/75; 430/20

(57) ABSTRACT

Methods for using and/or storing a pellicle-reticle assembly that does not result in the formation of haze on the reticle and/or the formation of wrinkles on the pellicle.

### BACKGROUND OF THE INVENTION

1. Field of the Invention

Embodiments of the present invention relate to, but are not limited to, electronic devices and micro-electromechanical system (MEMS) manufacturing, and in particular, to the field of electronic device and MEMS manufacturing tool usage and storage.

2. Description of Related Art

A photolithographic process is a process that is typically used in the manufacture of semiconductor devices and MEMS. The process generally involves forming photoresist patterns onto a substrate such as a wafer substrate, the photoresist patterns being eventually used to etch circuitry and/or component features onto the substrate.

In the process, the photoresist patterns are formed by initially depositing a layer of light-sensitive photoresist film onto the wafer surface. A reticle (i.e., photomask), which is typically made of quartz and having both transparent and nontransparent portions, is placed over the wafer covered with the photoresist film. Electromagnetic radiation, such as ultraviolet (UV) light, is then directed to the photoresist film through the reticle causing photochemical reactions to occur in those regions of the photoresist film that are underneath the transparent portions of the reticle. Depending upon whether the photoresist is a positive or a negative photoresist, the exposed portions will become soluble or not soluble in a developer solution. Once the photoresist film has been “exposed” to the electromagnetic radiation, the undesirable portions of the photoresist film is washed away leaving behind a photoresist pattern on top of the wafer substrate.

As features become smaller, it becomes more important to use manufacturing tools that are defect free. For example, it is generally preferable that the surface of reticles used during the electromagnetic radiation exposure process is free of foreign contaminants such as airborne particles since such particles may create unwanted shadows during the exposure process. Thus, such reticles are typically protected from foreign contaminants by a light-transparent polymeric film called a pellicle. A pellicle film, when coupled to a reticle, is separated from the reticle by a short distance sufficient to make the image of particles on the surface of processing wafer out of focus. Without the pellicle, such particles could create unintended images on the photoresist film and alter the proper formation of circuitry features on the substrate surface. For purposes of this description, the pellicle-reticle combination will be called a “pellicle-reticle assembly” or a “pellicle-reticle attachment or connection.” In a conventional photolithographic process, the pellicle-reticle assembly is typically used in a projection printer machine called a “stepper” during the exposure stage of the photolithographic process. While being used in the stepper, the pellicle-reticle assembly may be exposed to electromagnetic radiation having wavelengths anywhere from tens to hundreds of nanometers in length. When not in use, the pellicle-reticle assembly may be stored in a storage enclosure called a “stocker.” The use, transportation, and storage of a pellicle-reticle assembly are all typically done in normal atmospheric environments.

### BRIEF DESCRIPTION OF DRAWINGS

The present invention will be described by way of exemplary embodiments, but not limitations, illustrated in the accompanying drawings in which like references denote similar elements, and in which:

FIG. 1 illustrates an exemplary pellicle-reticle assembly;

FIG. 2 is a block diagram that illustrates the transfer of a pellicle-reticle assembly between two enclosures that are in vacuum or purged with an inert gas in accordance with some embodiments;

FIG. 3 illustrates a system for purging an enclosure with an inert gas in accordance with some embodiments; and

FIG. 4 illustrates a system for vacuuming an enclosure in accordance with some embodiments.

### DETAILED DESCRIPTION OF ILLUSTRATIVE EMBODIMENTS

In the following description, for purposes of explanation, numerous details are set forth in order to provide a thorough understanding of the disclosed embodiments of the present invention. However, it will be apparent to one skilled in the art that these specific details are not required in order to practice the disclosed embodiments of the present invention. In other instances, well-known devices and structures are shown in block diagram form in order not to obscure the disclosed embodiments of the present invention.

According to various embodiments of the invention, methods for using and storing a pellicle-reticle assembly with substantial reduction in haze formation on the reticle and/or wrinkle formation on the pellicle are provided. In various embodiments, a pellicle-reticle assembly is a tool that may be used in a photolithographic process for forming photoresist patterns. For these embodiments, the pellicle-reticle assembly comprises of a pellicle that is coupled to a reticle by a wall or frame. The pellicle, the reticle, and the wall or frame in the pellicle-reticle assembly may define an enclosure (for purposes of this description, to be called a “pellicle-reticle enclosure”).

In various embodiments, the pellicle-reticle assembly may be used and/or stored in an environment absent of atmospheric air and/or contaminants. For these embodiments, by removing or displacing atmospheric air and/or airborne contaminants from the pellicle-reticle enclosure and/or the surrounding environment, haze formation on the reticle and/or wrinkle formation of the pellicle may be prevented during the use, transportation, and/or storage of the pellicle-reticle assembly.

Wrinkles on pellicles may create non-preformed images on the surface of wafer (during transfer of photomask images on the wafer) due to non-uniform pellicle surface. Haze on photomask, on the other hand, may decrease the light intensity and depending on the haze film's thickness and haze film's light absorption, the original light intensity may decrease thus resulting in incomplete lithography during pattern formation on the photoresist.

In various embodiments, the pellicle-reticle enclosure contained within a pellicle-reticle assembly may be purged with an inert gas to discharge or displace atmospheric gas and/or contaminants from the pellicle-reticle enclosure. Formation of a haze on a reticle and/or wrinkling of a pellicle may be as a result of photochemical reaction between ultraviolet light, atmospheric gases, and/or contaminants such as materials that may found in semiconductor fabrication environments. By purging an inert gas into the pellicle-reticle enclosure, preexisting atmospheric gases as well as contaminants in the pellicle-reticle enclosure may be discharged. For these embodiments, the inert gas used to purge the pellicle-reticle enclosure may be nonreactive to ultraviolet light and may be denser than gases that make up atmospheric air. In some embodiments, the inert gas may be argon gas. For these embodiments, the inert gas may be dry particle free argon gas.

In various embodiments, instead of only purging the pellicle-reticle enclosure with inert gas, the entire pellicle-reticle assembly may be in a vacuum environment or enveloped in inert gas. For these embodiments, the pellicle-reticle assembly may be used in a first enclosure that is in vacuum or purged with an inert gas. The first enclosure, in various embodiments, may be part of a stepper machine used during the exposure stages of a photolithographic process. While in the stepper, the pellicle-reticle assembly may be exposed to ultraviolet radiation without haze forming on the reticle and/or wrinkles forming on the pellicle. In various embodiments, the pellicle-reticle assembly may be transferred between the first enclosure and a second enclosure that is also in vacuum or purged with an inert gas. The second enclosure may be used to store the pellicle-reticle assembly when the pellicle-reticle assembly is not being used in the stepper.

In various embodiments, the inert gas that may be used to purge the pellicle-reticle enclosure or to envelop the entire pellicle-reticle assembly is an inert gas that may not generate free radicals when exposed to electromagnetic radiation such as deep ultraviolet (DUV) radiation. In some embodiments, the inert gas may be denser than atmospheric gases such as nitrogen, oxygen, carbon dioxide, or water vapor. In some embodiments, the inert gas is argon gas or dry particle free argon gas.

In a photolithographic process, the transparent characteristics of a pellicle and a reticle in a pellicle-reticle assembly may be an important factor in facilitating the proper formation of circuitry features on, for example, a wafer. Thus, the formation of haze on a reticle and/or formation of wrinkles on a pellicle may reduce or may impact the formation of photoresist patterns and may ultimately result in lower manufacturing yields. That is, the presence of haze or wrinkles in a pellicle-reticle assembly during the exposure process of a photolithographic process may result in the formation of unwanted shadows or distortion of exposure radiation (e.g., ultraviolet radiation). As a result, circuitry features that are to be formed from the photolithographic process may be significantly compromised.

It has been found that formation of haze on a reticle and formation of wrinkles on a pellicle of a pellicle-reticle assembly may be as a result of various chemical reactions that may occur when ultraviolet radiation such as DUV radiation initiates photochemical reactions with gases of atmospheric air and/or environmental contaminants such as cleaning solvents that are often found in semiconductor fabrication environments. For example, salt crystals such as NH₄NO₃ and NH₄NO₂ and (NH₄)₂SO₄ may form as a result of the interaction between DUV exposure, gases of atmospheric air, and/or environmental contaminants. These salt crystals may deposit onto the surface of a reticle to form haze on the reticle. In many cases, exposure radiation used in a photolithographic process may include ultraviolet radiation such as DUV light. Note that as defined in this description, deep ultraviolet radiation is electromagnetic radiation having wavelengths between about 193 to about 204 nanometers (nm).

In contrast to haze formation, wrinkle formation in a pellicle may be as a result of the pellicle absorbing certain materials. For example, one type of material that may be absorbed by a pellicle to form wrinkles is free radicals that may form when atmospheric gases such as nitrogen and oxygen are exposed to DUV radiation. Another possible source for wrinkles is when contaminates, such as cleaning solvents that are commonly found in semiconductor fabrication environments, are absorbed by the pellicle. Examples of such contaminates include organic vapors and inorganic gases such as organic amines, SO₂ and NH₃.

In an atmospheric air environment, the sources of salt crystals such as those described above has been traced back to at least two sets of chemical reactions. Each set of chemical reactions represent chains of chemical reactions that involve at least the gases of atmospheric air such as nitrogen, oxygen and water vapor, and/or contaminants being exposed to DUV radiation. The first set of reactions is as follows:
2O₂ (in the presence of DUV)→2O₃ (ozone)
2O₃+N₂ (in the presence of DUV)→2NO^{.} (free radical)+2O₂
2NO^{.} (in the presence of DUV)→N₂0₂
N₂O₂+O₃ (in the presence of DUV)→N₂0₃+0₂
N₂0₃+H₂0→2H⁺+2NO₂⁻ (nitrite)
N₂0₃+20₃→N₂0₅+20₂
N₂0₅+H₂0→2H⁺+2NO₃⁻ (nitrate)
NO₃⁻+NH₄⁺→NH₄NO₃ (crystals, haze)
NO₂⁻+NH₄⁺→NH₄NO₂ (crystals, haze)

In the above reactions, ozone (O₃) and free radicals (NO.) are formed from atmospheric gases such as nitrogen and oxygen in the presence of DUV. These free radicals, in combination with each other and other atmospheric gases including water and ammonia gases may form NH₄NO₃ and NH₄NO₂ crystals. These crystals, when deposited onto a reticle, will form a haze on the surface of the reticle. Note that the free radicals that are formed via the above chemical reaction may also be absorbed by a pellicle to form wrinkles on the pellicle.

The second set of chemical reactions is as follows:
Glass→SiOH in the surface
SiOH→SiO⁻ in a basic environment+H₂0
SiO⁻+NH₄⁺→SiONH₄
3O₂ (in gas phase)→2O₃ (formation of ozone in DUV light)
SO₃+H₂O→H₂SO₄ in gas phase (2H⁺+SO₄⁼ in ionization form)
SO₄⁼+2NH₄⁺→(NH₄)₂SO₄ (Crystal Haze)

In the second set of chemical reactions, the combination of reticle surface materials such as SiOH, contaminants such as NH₄⁺ ions, SO₂ or SO₃ gases or atmospheric gases such as oxygen, water vapor, and DUV, may all combine in a set of chemical reactions to form salt crystals such as ammonium sulfate (NH₄)₂SO₄. In this set of chemical reactions, the SiOH can easily react with NH₄⁺ to form (SiNH₄), and later its reaction with anions such as SO4⁼ produce the salt of (NH₄)₂SO₄. The resulting salt crystals (e.g., (NH₄)₂SO₄) may be deposited onto the surface of the reticle to form a haze on the reticle.

By displacing atmospheric gases and/or contaminants in and around a pellicle-reticle assembly, haze and wrinkle formation on the pellicle-reticle assembly's reticle and pellicle may be prevented. In various embodiments, at least two approaches may be employed to achieve such displacement. In the first approach, the pellicle-reticle enclosure in the pellicle-reticle assembly or the entire pellicle-reticle assembly may be purged with an inert gas. In the second approach, the pellicle-reticle enclosure in the pellicle-reticle assembly or the entire pellicle-reticle assembly may be in vacuum. In both approaches, atmospheric gases and/or contaminants are removed or displaced from within the pellicle-reticle assembly and/or the surrounding environments.

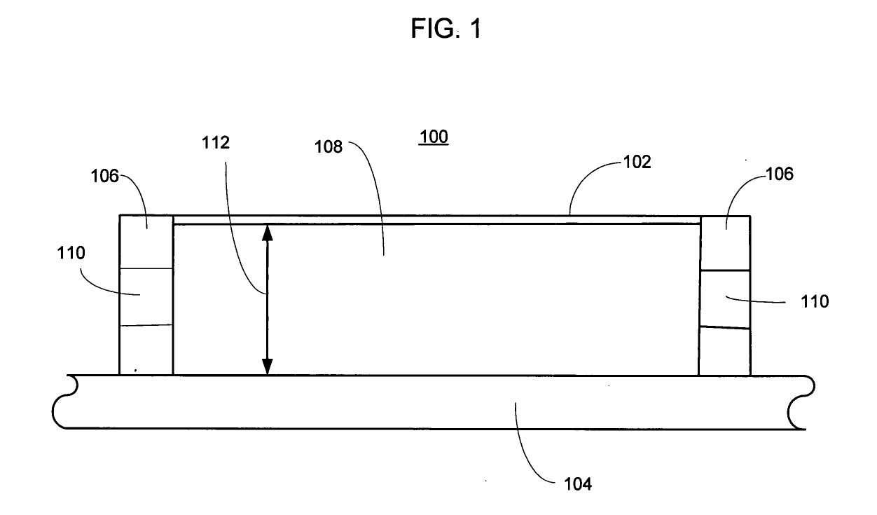

In various embodiments, a pellicle-reticle enclosure in a pellicle-reticle assembly may be purged with an inert gas in order to prevent the formation of haze on the reticle surface and/or wrinkles on the pellicle. Referring to FIG. 1, which depicts a pellicle-reticle assembly 100 in accordance with some embodiments. For the embodiments, the pellicle-reticle assembly 100 includes a pellicle 102 coupled to a reticle 104 by a wall 106. Note that although the wall 106 in this embodiment is depicted as being a solid wall, in various other embodiments, the wall 106 may be a wire frame or any other porous or nonporous structure with an inlet-outlet orifice (to ease and control the gas flow and its pressure between 104 and 102 chamber). A pellicle-reticle enclosure 108 is formed between the pellicle 102 and the reticle 104. One or more orifice 110 (gas inlet, gas outlet) may be present in the wall 106 to allow for venting of the pellicle-reticle enclosure 108 between the pellicle 102 and the reticle 104. In some embodiments, both a gas outlet orifice and a gas inlet orifice may be present. For these embodiments, the gas outlet orifice may be larger than the gas inlet orifice to eliminate any gas pressure build up between the reticle 104 and the pellicle 102 (i.e., the pellicle-reticle enclosure 108) during inert gas purging.

The distance 112 between the pellicle 102 and the reticle 104 may be set to assure that airborne particles that may settle on top of the pellicle 102 does not form shadows on a photoresist film that is to be imaged during the exposure process of the photolithographic process. That is, by having the pellicle 102 located sufficiently away from the reticle 104, the airborne particle's image will be out of focus on the surface of wafer during light exposure. In some embodiments, the distance 112 between the pellicle 102 and the reticle 104 is about 1 cm.

In various embodiments, the pellicle-reticle enclosure 108 may be purged with an inert gas in order to displace the atmospheric gases or contaminants that may be contained in the pellicle-reticle enclosure 108. By discharging atmospheric gases from the pellicle-reticle enclosure 108 via inert gas purge, haze formation on the reticle and/or wrinkle formation on the pellicle may be reduced or prevented.

For the embodiments, the inert gas may be a gas that does not form free radicals when exposed to ultraviolet radiation such as DUV. In some embodiments, the inert gas may be denser than the gases that primarily make up atmospheric air such as oxygen, nitrogen, carbon dioxide, water vapor, and the like. By using an inert gas that is denser than atmospheric gases in the pellicle-reticle enclosure 108, diffusion of low-density atmospheric gases into this highly dense gas environment becomes slower or even eliminated. Further, the use of a relatively dense inert gas may assure that contaminants such as a solvent's vapors that are often found in semiconductor fabrication environments are purged away from the pellicle-reticle enclosure 108 or the pellicle-reticle assembly 100 itself. In various embodiments, the inert gas may be a gas that photochemically is inert during UV light exposure and as a result does not form any free radicals. In some embodiments, the inert gas is argon gas such as pure dry particle free argon gas. A pure dry particle free argon gas, as defined here, is argon gas that is substantially free of moisture, oxygen, nitrogen or any contaminants that can form haze on the photomask or wrinkles on the pellicles.

According to various embodiments, a pellicle-reticle assembly may be used and stored in enclosures that are in vacuum or purged with an inert gas such as those described previously. For the embodiments, the use and storage of a pellicle-reticle assembly 100 in vacuum or inert gas environments may assure that the pellicle-reticle assembly 100 is free from haze and wrinkles. That is, by using and storing the pellicle-reticle assembly 100 in such environments, the pellicle-reticle enclosure 108 in the pellicle-reticle assembly 100 as well as the environment surrounding the pellicle-reticle assembly 100 may be free of atmospheric gases and/or contaminants.

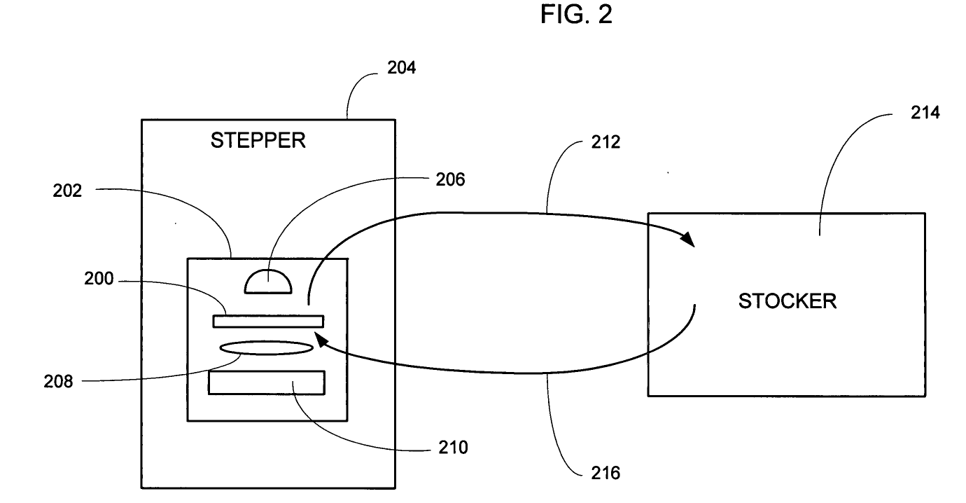

FIG. 2 depicts a pellicle-reticle assembly being transferred between a first and a second enclosure, each enclosure being in vacuum, or purged with an inert gas, to prevent haze and/or wrinkle formation in accordance with some embodiments. For the embodiments, a pellicle-reticle assembly 200 may be placed in a first enclosure 202 when being used, for example, in a photolithographic process. The first enclosure 202 may be part of a stepper 204 used to imprint photoresist images onto, for example, a wafer or a die. In various embodiments, the first enclosure 202 may further include an exposure light source 206 such as an UV light source and a projection lens 208.

The exposure light source 206 may direct electromagnetic radiation such as DUV to a substrate 210 (e.g., wafer) by transmitting the radiation through the pellicle-reticle assembly 200. In various embodiments, the first enclosure 202 may be in vacuum or purged with an inert gas such as those described previously in order to prevent haze and/or wrinkle formation of the pellicle-reticle assembly 200. Note that in some embodiments, preexisting atmospheric gases in the first enclosure 202 may be displaced or removed (via vacuum or inert gas purge) prior to placing the pellicle-reticle assembly 200 inside the first enclosure 202. In other embodiments, however, the preexisting atmospheric gases contained in the first enclosure 202 may be removed after the placement of the pellicle-reticle assembly 200 inside the first enclosure 202.

According to some embodiments, the pellicle-reticle assembly 200 may be transferred (as indicated by ref. 212) and stored in a second enclosure 214 when not in use, for example, in the stepper 204. The second enclosure 214 may be part of a stocker for storing pellicle-reticle assemblies. In various embodiments, the second enclosure 214 may also be in vacuum or purged with an inert gas such as those described previously. By storing the pellicle-reticle assembly 200 in a second enclosure 214 that is purged with inert gas, haze and wrinkles of the pellicle-reticle assembly 200 may be further prevented. Once a need for the pellicle-reticle assembly 200 arises, the pellicle-reticle assembly 200 may be transferred back to the first enclosure 204 (as indicated by ref. 216).

In some embodiments, the transfer of the pellicle-reticle assembly 200 between the first and second enclosures 202 and 214 may be performed entirely in vacuum or in an inert gas environment. For example, the transfer of the pellicle-reticle assembly 200 between the first and second enclosures 202 and 214 may be made via a path that is in vacuum or enveloped in inert gas such as a tunnel that is in vacuum or filled with the inert gas and that may connect the first and second enclosures 202 and 214. The movement of the pellicle-reticle assembly 200 along the path may be performed, for example, using an automated or semiautomated system.

In alternative embodiments, the pellicle-reticle assembly 200 may be stored in the first enclosure 202 rather than being transferred to the second enclosure 214 for storage purposes. Such a scheme may simplify the storage and use of the pellicle-reticle assembly 200 while still assuring that haze and wrinkling do not form in the pellicle-reticle assembly 200.

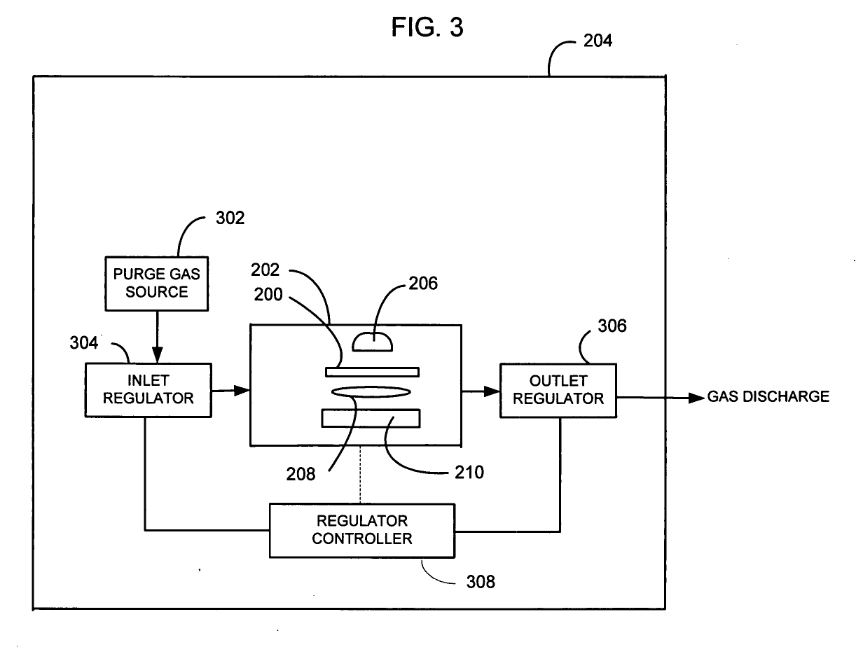

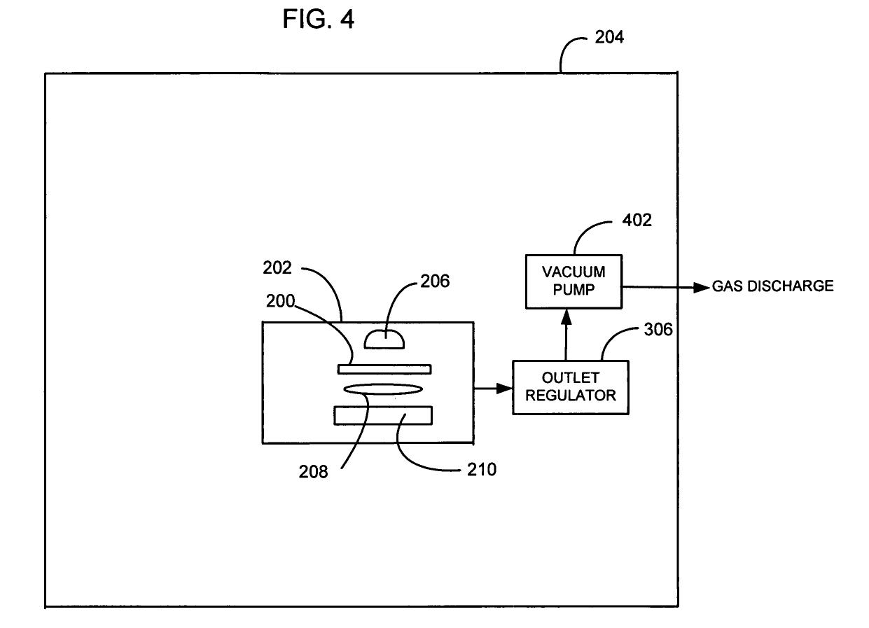

FIGS. 3 and 4 depict systems for displacing an initial gas from an enclosure using a gas displacement component such as a purge gas source and/or a vacuum pump in accordance with various embodiments. In particular, FIG. 3 depicts a system for displacing a first or initial gas from an enclosure by purging the enclosure with a second gas using a purge gas source in accordance with some embodiments. For these embodiments, the first gas may comprise of atmospheric gas or gases and the second gas may be an inert gas such as argon gas. In some embodiments, the enclosure 202 may be part of a stepper 204 and may receive or contain a pellicle-reticle assembly 200. The enclosure 202 may be connected to a gas displacement component, in this case, a purge gas source 302 via an inlet regulator 304. The enclosure 202 may further be connected to a outlet regulator 306, which allows gas (e.g., first gas) being discharged from the enclosure 202 to be discharged into a discharge tank (not shown) and/or out to ambient atmosphere. Each of the inlet regulator 304 and the outlet regulator 306 may be coupled to a regulator controller 308. Note that although in these embodiments, the inlet and outlet regulators 304 and 306, the purge gas source 302 and the regulator controller 308 are located within the stepper 204, in other embodiments, these components may be external to the stepper 204.

For the embodiments, the enclosure 202 may be a sealed enclosure that may have sufficient structural integrity to maintain the seal of the enclosure 202 regardless of the pressure differential between the internal pressure of the enclosure 202 and external environment. In addition to the pellicle-reticle assembly 200, the enclosure 202 may contain an exposure light source 206, a projection lens 208 and a substrate 210 (e.g., wafer substrate) that is to be exposed during, for example, a photolithography process. In alternative embodiments, the exposure light source 206, the projection lens 208 and the substrate 210 may actually be located outside of the enclosure 202.

According to various embodiments, the purge gas source 302 may be a pressurized gas source that may contain an inert gas such as argon gas. For the embodiments, the purge gas source 302 may include a pressurized vessel such as a tank, a cylinder or some other vessel. The purge gas source 302 may further include a compressor or a blower to maintain or increase the pressure of the purge gas to be supplied to the enclosure 202.

In various embodiments, the inlet and outlet regulators 304 and 306 may be used to control the flow of a purge gas into the enclosure 202 and to regulate the outflow of an initial gas such as atmospheric air that may be contained in the enclosure 202. For these embodiments, the inlet and outlet regulators 304 and 306 may be some type of a control valve. In some embodiments, the inlet and outlet regulators 304 and 306 may be manually controlled. In other embodiments, the inlet and outlet regulators 304 and 306 may be controlled by a semi or fully automated controller such as the regulator controller 308 depicted in FIG. 3. The regulator controller 308 may be further coupled to one or more sensors (not shown) that may be located in or coupled to the enclosure 202. The one or more sensors may provide internal environmental information such as pressure and gas concentration data of the enclosure 202. Based on the data provided by the sensors, the regulator controller 308 may direct the inlet and outlet regulators 304 and 306 to either open or close.

FIG. 4 depicts a system for displacing or removing an initial gas from an enclosure by using a vacuum pump to extract the initial gas from the enclosure in accordance with some embodiments. For these embodiments, the initial gas may comprise of atmospheric gas or gases. In some embodiments, the enclosure 202 may be part of a stepper 204 and may receive or contain a pellicle-reticle assembly 200. The enclosure 202 may be connected to a gas displacement component, in this case, a vacuum pump 402, via an outlet regulator 306.

In various embodiments, the vacuum pump 402 may create a vacuum enclosure by removing the initial gas contained in the enclosure 202 and discharging the gas into a discharge tank (not shown) and/or out to ambient atmosphere. The outlet regulator 306 may be a valve to assure that the enclosure 202 is hermetically sealed. The outlet regulator 306 may be manually or automatically opened or closed.

In some embodiments, both the outlet regulator 306 and the vacuum pump 402 may be coupled to a semi or a fully automated digital control system (not shown). The automated digital control system may further be coupled to sensors that may monitor environmental conditions within the enclosure 202. Based on the data received from the sensors, the outlet regulator 306 and the vacuum pump 402 may be activated to ensure the enclosure 202 is in vacuum. Note that although in these embodiments the outlet regulator 306 and the vacuum pump 402 are disposed within the stepper 204, in other embodiments, these components may be external to the stepper 204.

For the embodiments, the enclosure 202 may be a sealed enclosure that may have sufficient structural integrity to maintain the seal of the enclosure 202 regardless of the pressure differential between the internal pressure of the enclosure 202 and external environment. In addition to the pellicle-reticle assembly 200, the enclosure 202 may contain an exposure light source 206, a projection lens 208 and a substrate 210 (e.g., wafer substrate) that is to be exposed during, for example, a photolithography process. In alternative embodiments, the exposure light source 206, the projection lens 208 and the substrate 210 may actually be located outside of the enclosure 202.

Although specific embodiments have been illustrated and described herein, it will be appreciated by those of ordinary skill in the art that any arrangement which is calculated to achieve the same purpose may be substituted for the specific embodiment shown. This application is intended to cover any adaptations or variations of the embodiments of the present invention. Therefore, it is manifestly intended that embodiments of this invention be limited only by the claims.

What is claimed is:

1. A method, comprising:
providing a pellicle-reticle assembly, the pellicle-reticle assembly comprising a pellicle coupled to a reticle, the pellicle and the reticle defining an enclosure between the pellicle and the reticle; and
displacing a first gas in the enclosure to prevent formation of at least a selected one of haze on the reticle or wrinkles on the pellicle.

2. The method of claim 1, wherein said displacing comprises vacuuming the enclosure.

3. The method of claim 1, wherein said displacing comprises purging the enclosure with a second gas, the second gas being an inert gas.

4. The method of claim 3, wherein the inert gas has a density denser than atmospheric gases.

5. The method of claim 3, wherein the inert gas comprises a dry particle free inert gas.

6. The method of claim 3, wherein the inert gas comprises an argon gas.

7. The method of claim 1, wherein the first gas comprises an atmospheric gas.

8. The method of claim 1, wherein the first gas comprises contaminants.

9. The method of claim 1, further comprises exposing the pellicle-reticle assembly with ultraviolet radiation.

10. A method, comprising:
providing a pellicle-reticle assembly, the pellicle-reticle assembly comprising a pellicle coupled to a reticle, the pellicle and the reticle defining an enclosure between the pellicle and the reticle; and
displacing a first gas in the enclosure to prevent formation of free radicals when the first gas is exposed to ultraviolet radiation.

11. The method of claim 10, wherein said displacing comprises vacuuming the enclosure.

12. The method of claim 10, wherein said displacing comprises purging the enclosure with a second gas, the second gas being an inert gas.

13. The method of claim 12, wherein the inert gas has a density denser than atmospheric gases.

14. The method of claim 12, wherein the inert gas comprises argon gas.

15. The method of claim 10, wherein the first gas is an atmospheric gas.

16. The method of claim 10, further comprising exposing the pellicle-reticle assembly with ultraviolet radiation.

17. A method, comprising:
providing a first enclosure;
placing a pellicle-reticle assembly in the enclosure, the pellicle-reticle assembly comprising a pellicle coupled to a reticle; and
displacing a first gas in the first enclosure to prevent formation of at least a selected one of haze on the reticle or wrinkles on the pellicle-reticle assembly.

18. The method of claim 17, wherein said displacing is performed prior to said placing.

19. The method of claim 17, wherein said displacing comprises vacuuming the first enclosure.

20. The method of claim 17, wherein said displacing comprises purging the first enclosure with a second gas.

21. The method of claim 20, wherein the second gas comprises dry particle free argon gas.

22. The method of claim 17, wherein the first gas is atmospheric gas.

23. The method of claim 17, wherein the first enclosure comprises a stepper enclosure.

24. The method of claim 17, further comprising transferring the pellicle-reticle assembly to a second enclosure, the second enclosure is a selected one of a vacuumed enclosure or an inert gas purged enclosure.

25. The method of claim 24, wherein the second enclosure comprises a stocker enclosure.

26. A system comprising
a stepper;
an enclosure disposed within the stepper, the enclosure to receive a pellicle-reticle assembly; and
a gas displacement component connected to the enclosure to displace a first gas in the first enclosure to prevent formation of at least a selected one of haze on the reticle or wrinkles on the pellicle-reticle assembly.

27. The system of claim 26, wherein said first gas is atmospheric gas.

28. The system of claim 26, wherein the gas displacement component comprises a purge gas source.

29. The system of claim 28, wherein the purge gas source to contain argon gas.

30. The system of claim 26, wherein the gas displacement component comprises a vacuum pump.
